(19) United States
(12) Patent Application Publication
(10) Pub. No.: US 2019/0309208 A1
(43) Pub. Date: Oct. 10, 2019

(54) Engineered Lubricant

(71) Applicant: Novogy, Inc., Cambridge, MA (US)

(72) Inventors: Denis Giorno, San Francisco, CA (US); Vineet Badriprasad Rajgarhia, Dublin, CA (US); Olivier Vidalin, Paris (FR); Arthur J Shaw, IV, Belmont, MA (US); Vasiliki Tsakraklides, Lexington, MA (US)

(21) Appl. No.: 16/069,973

(22) PCT Filed: Jan. 13, 2017
(86) PCT No.: PCT/US17/13390

§ 371 Date: Jul. 13, 2018

Related U.S. Application Data
(60) Provisional application No. 62/278,519, filed on Jan. 14, 2016.

(51) Int. Cl. C09K 8/08; E21B 21/00

(52) U.S. Cl. CPC C09K 8/08; C09K 2208/34; E21B 21/00

(57) ABSTRACT

Disclosed are compositions for drilling and/or maintaining a wellbore, e.g., drilling fluids and drilling muds, comprising oleaginous yeast. The oleaginous yeast may comprise at least about 45 wt % oil. The oleaginous yeast may comprise a genetic modification that either increases the oil content of the yeast, alters the lipid composition of the yeast, and/or provides a selective advantage for the yeast, e.g., relative to an unmodified yeast of the same species.

### CROSS-REFERENCE TO RELATED APPLICATIONS

This application claims the benefit of International Application No. PCT/US2017/013390, filed Jan. 13, 2017, which claims priority to U.S. Provisional Patent Application No. 62/278,519, filed Jan. 14, 2016, which are herein incorporated by reference in their entireties for all purposes.

### BACKGROUND

When drilling into subterranean formations, drilling fluids serve to cool and lubricate the drill bit. Drill bits often encounter increasing downhole friction arising from changes in downhole pressures, changes in the geological makeup of a formation, and changes in the direction of the drilling, especially when drilling a horizontal well. The increase in friction can lead to a reduced rate of penetration, and limit the ability of the drill bit to reach its target destination accurately and efficiently. For example, increasing the rotational torque of a drill bit to address increasing frictional changes can lead to corkscrewing of the drill bit from its intended path and/or buckling of the pipe. Increased friction can also accelerate wear on the drill bit, decreasing service lifetimes and increasing the need for equipment maintenance and replacement.

Current methods for reducing downhole friction typically involve the addition of lubricants to the drilling fluid. Diesel was initially used as a lubricant, but diesel-based lubricants were phased out when the drilling waste generated with use of such lubricants became classified as hazardous waste. Glycols and fatty acid esters may be used as alternate lubricants, as well as mechanical lubricants, such as glass beads, plastic beads, and graphite. Less expensive lubricants and lubricants with improved properties, however, remain desirable.

### SUMMARY

One aspect of the invention relates to a composition for use in drilling or maintaining a wellbore, comprising an oleaginous yeast, wherein the composition is a drilling fluid or drilling mud.

In some aspects, the invention relates to a method for drilling or maintaining a wellbore, comprising the step of drilling the wellbore with a drilling rig, wherein the wellbore comprises a composition comprising an oleaginous yeast.

In some aspects, the invention relates to a method for drilling or maintaining a wellbore, comprising the steps of contacting a drill bit or a drill rod with a composition comprising an oleaginous yeast, and drilling the wellbore with the drill bit or the drill rod.

In some embodiments, the oleaginous yeast comprises a genetic modification. For example, the genetic modification may increase the oil content of the oleaginous yeast, alter the lipid composition of the oleaginous yeast, or provide a selective advantage for the oleaginous yeast, relative to an unmodified yeast of the same species.

In some embodiments, an oleaginous yeast comprises at least about 45 wt % oil. In some embodiments, at least about 10 wt % of lipids of an oleaginous yeast may be oleic acid. In some embodiments, less than about 10 wt % of the lipids of an oleaginous yeast are polyunsaturated. In certain embodiments, the oleaginous yeast is not Rhodoturula glutinis.

### BRIEF DESCRIPTIONS OF THE DRAWINGS

FIG. 1 is two pictures of drilling fluids comprising oleaginous yeast strain N432. The pictures show visible solids observed during testing in an OFITE Lubricity and Extreme Pressure Tester.

FIG. 2 is a graph showing the friction factor of drilling fluid comprising various amounts of oil as a lubricant, supplied as yeast strain N432, versus time in an OFITE Lubricity and Extreme Pressure Tester.

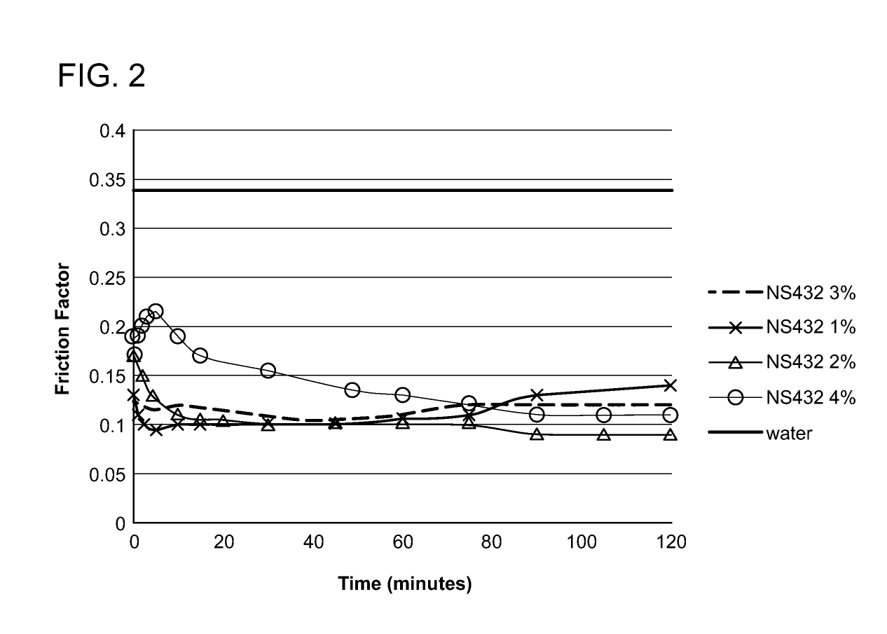

FIG. 3 is a graph showing the friction factor of drilling fluids comprising no lubricant (“Mud”), 3% Baroid BaroLube GoldSeal lubricant, or 3% oil supplied as yeast strain NS432, versus time in an OFITE Lubricity and Extreme Pressure Tester. Water is plotted as a negative control.

### DETAILED DESCRIPTION

Some aspects of the invention relate to the finding that oleaginous yeast can decrease the friction factor of a drilling fluid.

### Definitions

The articles “a” and “an” are used herein to refer to one or to more than one (i.e., to at least one) of the grammatical object of the article. By way of example, “an element” means one element or more than one element.

The term “activity” refers to the total capacity of a cell to perform a function. For example, a genetic modification that decreases the activity of an enzyme in a cell may reduce the amount of the enzyme in a cell or reduce the efficiency of the enzyme. A knockout reduces the activity of a protein by reducing the amount of the protein in the cell. Alternatively, a mutation to a gene may reduce the efficiency of its protein product with little effect on the amount of the protein in the cell. Mutations that reduce the efficiency of an enzyme may affect the active site, for example, by changing one or more active site residues; they may impair the enzyme's kinetics, for example, by sterically blocking substrates or products; they may affect protein folding or dynamics, for example, by reducing the proportion of properly-folded enzymes; they may affect protein localization, for example, by preventing the protein from localizing to lipid particles; or they may affect protein degradation, for example, by adding one or more protein cleavage sites or by adding one or more residues or amino acid sequences that target the protein for proteolysis. These mutations affect coding regions. Mutations that decrease the activity of a protein may instead affect the transcription or translation of the gene. For example, mutation of an enhancer or promoter can reduce the activity of a protein by reducing its expression. Mutating or deleting the non-coding portions of a gene, such as its introns, may also reduce transcription or translation. Additionally, mutations to the upstream regulators of a gene may affect the activity of its protein product; for example, the over-expression of one or more repressors may decrease the activity of a protein, and a knockout or mutation of one or more activators may similarly decrease the activity of a protein.

A genetic modification that increases the activity of a protein in a cell may increase the amount of the protein in the cell or increase the efficiency of the protein (e.g., the efficiency of an enzyme). For example, the genetic modification may simply insert an additional copy of the protein into the cell such that the additional copy is transcribed and translated into additional functional protein. The added gene can be native to the host organism or from a different organism. Alternatively, mutating or deleting the non-coding portions of a gene, such as its introns, may also increase translation. A native gene can be altered by adding a new promoter that causes more transcription. Similarly, enhancers may be added to the gene to increase transcription, or silencers may be mutated or deleted from the gene to increase transcription. Mutations to a native gene's coding region might also increase the activity of the protein, for example, by producing a protein variant that does not interact with inhibitory proteins or molecules. The over-expression of one or more activators may increase the activity of a protein by increasing the expression of the protein, and a knockout or mutation of one or more repressors may similarly increase the activity of the protein.

The term “biologically-active portion” refers to an amino acid sequence that is less than a full-length amino acid sequence, but exhibits at least one activity of the full length sequence. For example, a biologically-active portion of a diacylglycerol acyltransferase may refer to one or more domains of DGA1, DGA2, or DGA3 having biological activity for converting acyl-CoA and diacylglycerol to triacylglycerol. Typically, biologically-active portions comprise a domain or motif having a catalytic activity, such as catalytic activity for producing a molecule in a fatty acid biosynthesis pathway. A biologically-active portion of a protein includes portions of the protein that have the same activity as the full-length peptide and every portion that has more activity than background. For example, a biologically-active portion of an enzyme may have 0.1%, 0.5%, 1%, 2%, 3%, 4%, 5%, 10%, 25%, 30%, 35%, 40%, 45%, 50%, 55%, 60%, 65%, 70%, 75%, 80%, 85%, 86%, 87%, 88%, 89%, 90%, 91%, 92%, 93%, 94%, 95%, 96%, 97%, 98%, 99%, 99.5%, 99.6%, 99.7%, 99.8%, 99.9%, 100%, 100.1%, 100.2%, 100.3%, 100.4%, 100.5%, 100.6%, 100.7%, 100.8%, 100.9%, 101%, 105%, 110%, 115%, 120%, 125%, 130%, 135%, 140%, 145%, 150%, 160%, 170%, 180%, 190%, 200%, 220%, 240%, 260%, 280%, 300%, 320%, 340%, 360%, 380%, 400% or higher activity relative to a full-length enzyme. A biologically-active portion of a protein may include portions of a protein that lack a domain that targets the protein to a cellular compartment.

The term “domain” refers to a part of the amino acid sequence of a protein that is able to fold into a stable three-dimensional structure independent of the rest of the protein.

The terms “drilling fluid” and “drilling mud” are used interchangeably herein, and include fluid compositions for drilling or maintaining a wellbore.

“Dry weight” and “dry cell weight” mean weight determined in the relative absence of water. For example, reference to oleaginous yeast as comprising a specified percentage of a particular component by dry weight means that the percentage is calculated based on the weight of the cell after substantially all water has been removed.

The term “encode” refers to nucleic acids that comprise a coding region, portion of a coding region, or compliments thereof. Both DNA and RNA may encode a gene. Both DNA and RNA may encode a protein.

The term “expression” refers to the amount of a nucleic acid or amino acid sequence (e.g., peptide, polypeptide, or protein) in a cell. The increased expression of a gene refers to the increased transcription of that gene. The increased expression of an amino acid sequence, peptide, polypeptide, or protein refers to the increased translation of a nucleic acid encoding the amino acid sequence, peptide, polypeptide, or protein.

The term “fatty acid” refers to aliphatic chains comprising a carboxylic acid and derivatives thereof, including diglycerides, triglycerides, and phospholipids. In preferred embodiments, a fatty acid can be produced by a natural or engineered biosynthetic pathway in yeast, e.g., from other fatty acids or from acetyl-CoA.

The term “gene,” as used herein, may encompass genomic sequences that contain exons, particularly polynucleotide sequences encoding polypeptide sequences involved in a specific activity. The term further encompasses synthetic nucleic acids that did not derive from genomic sequence. In certain embodiments, the genes lack introns, as they are synthesized based on the known DNA sequence of cDNA and protein sequence. In other embodiments, the genes are synthesized, non-native cDNA wherein the codons have been optimized for expression in Y. lipolytica based on codon usage. The term can further include nucleic acid molecules comprising upstream, downstream, and/or intron nucleotide sequences.

The term “genetic modification” refers to the result of a transformation. Transformation refers to the transfer of a nucleic acid into a host organism resulting in genetically stable inheritance. Every transformation causes a genetic modification by definition.

The term “knockout mutation” or “knockout” refers to a genetic modification that prevents a native gene from being transcribed and translated into a functional protein.

The term “native” refers to the composition of a cell or parent cell prior to a transformation event. A “native gene” refers to a nucleotide sequence that encodes a protein that has not been introduced into a cell by a transformation event. A “native protein” refers to an amino acid sequence that is encoded by a native gene.

The term “oil” refers to lipids. Examples of lipids include fatty acids (saturated and unsaturated); molecules comprising at least one fatty acid; glycerides or glycerolipids (such as monoglycerides, diglycerides, triglycerides, neutral fats, phosphoglycerides, and glycerophospholipids); nonglycerides (sphingolipids, sterol lipids including cholesterol, steroid hormones, prenol lipids including terpenoids, fatty alcohols, waxes, and polyketides); and complex lipid derivatives (sugar-linked lipids, glycolipids, and protein-linked lipids).

The terms “triacylglyceride,” “triacylglycerol,” “triglyceride,” and “TAG” are esters comprising glycerol and three fatty acids.

The term “wt % oil” refers to the weight of oil (i.e., lipid molecules) in a cell as a percentage of dry cell weight.

### I. Overview

One aspect of the invention relates to a composition for use in drilling or maintaining a wellbore, comprising an oleaginous yeast.

In some aspects, the invention relates to a method for drilling or maintaining a wellbore, comprising the step of drilling the wellbore with a drilling rig, wherein the wellbore comprises a composition comprising an oleaginous yeast.

In some aspects, the invention relates to a method for drilling or maintaining a wellbore, comprising the steps of contacting a drill bit or a drill rod with a composition comprising an oleaginous yeast, and drilling the wellbore with the drill bit or the drill rod.

In some embodiments, the yeast comprises a genetic modification. For example, the genetic modification may increase the oil content of the yeast, the genetic modification may alter the lipid composition of the yeast, or the genetic modification may provide a selective advantage for the yeast, relative to an unmodified yeast of the same species.

### II. Drilling Fluid Compositions

Various aspects of the invention relate to compositions that may be used as a drilling fluid or drilling mud. A composition may be used for production of oil or natural gas, for completion operations, sand control operations, workover operations, and for pumping-services, such as cementing, hydraulic fracturing, and acidification. A composition may be a drilling fluid, a drill-in fluid, a workover fluid, a spotting fluid, a cementing fluid, a reservoir fluid, a production fluid, a fracturing fluid, or a completion fluid.

In certain embodiments, a composition of the invention comprises an oleaginous yeast. A composition may not comprise an oleaginous yeast, however, for example, when the composition is used in a method wherein the method comprises adding the oleaginous yeast to the composition. The oleaginous yeast may be intact, lysed, or partly lysed. The yeast may be dried. For example, the yeast may be supplied as dried yeast, or as a cake or a cream. The ability to supply a composition as dried yeast or as a cake or cream provides advantages for handling and transporting the composition, relative to algae or bacterial-based additives, that may lyse upon drying. In some embodiments, the yeast comprises less than 10 wt % water, such as less than 5 wt % water. Thus, a composition of the invention may comprise oleaginous yeast, wherein the oleaginous yeast are dried yeast. Similarly, a composition may comprise oleaginous yeast, wherein the yeast comprise less than 10 wt % water, less than 9 wt % water, less than 8 wt % water, less than 7 wt % water, less than 6 wt % water, less than 5 wt % water, less than 4 wt % water, less than 3 wt % water, or even less than 2 wt % water.

A composition of the invention may comprise about 0.1% to about 20% of the oleaginous yeast (i.e., by weight), such as about 0.2% to about 10% oleaginous yeast, about 0.5% to about 5% oleaginous yeast, or about 1% to about 4% oleaginous yeast. A composition of the invention may comprise about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, or 7.0% oleaginous yeast (i.e., by weight).

A composition of the invention may comprise 50% to 100% oleaginous yeast by weight, e.g., wherein the composition is a drilling fluid additive (e.g., a lubricant). A composition may comprise 60% to 100% oleaginous yeast, 70% to 100% oleaginous yeast, 80% to 100% oleaginous yeast, 90% to 100% oleaginous yeast, or 95% to 100% oleaginous yeast. A composition may comprise at least 60%, 70%, 75%, 80%, 85%, 90%, 91%, 92%, 93%, 94%, 95%, 96%, 97%, 98%, or 99% oleaginous yeast. A composition may comprise 90%, 91%, 92%, 93%, 94%, 95%, 96%, 97%, 98%, 99%, or 100% oleaginous yeast. Compositions comprising at least 60% oleaginous yeast may be in the form of a cake or a cream and, e.g., such compositions may comprise less than 10 wt % water, less than 9 wt % water, less than 8 wt % water, less than 7 wt % water, less than 6 wt % water, less than 5 wt % water, less than 4 wt % water, less than 3 wt % water, or even less than 2 wt % water.

A composition of the invention may comprise about 0.1% to about 20% oil by weight, such as about 0.2% to about 10% oil, about 0.5% to about 5% oil, or about 1% to about 4% oil, e.g., wherein the composition comprises oleaginous yeast and the oleaginous yeast comprise at least half of the oil in the composition. For example, a composition may comprise oleaginous yeast and about 0.1% to about 20% oil, and the oleaginous yeast may comprise substantially all of the oil in the composition. A composition of the invention may comprise about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, or 7.0% oil by weight.

A composition of the invention may comprise about 0.1% to about 20% fatty acids by weight, such as about 0.2% to about 10% fatty acids, about 0.5% to about 5% fatty acids, or about 1% to about 4% fatty acids, e.g., wherein the composition comprises oleaginous yeast and the oleaginous yeast comprise at least half of the fatty acids in the composition. For example, a composition may comprise oleaginous yeast and about 0.1% to about 20% fatty acids, and the oleaginous yeast may comprise substantially all of the fatty acids in the composition. A composition of the invention may comprise about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, or 7.0% fatty acids by weight.

A composition of the invention may comprise water, e.g., fresh water.

A composition of the invention may comprise sodium carbonate, e.g., at a concentration of about 100 g/m³ to about 10 kg/m³, such as about 200 g/m³ to about 5 kg/m³, or about 500 g/m³ to about 2 kg/m³.

A composition of the invention may comprise sodium hydroxide, e.g., at a concentration of about 100 g/m³ to about 10 kg/m³, such as about 200 g/m³ to about 5 kg/m³, or about 500 g/m³ to about 2 kg/m³.

A composition of the invention may comprise sodium chloride, e.g., at a concentration of about 10 kg/m³ to about 500 kg/m³, such as about 25 kg/m³ to about 400 kg/m³, or about 50 kg/m³ to about 250 kg/m³.

A composition of the invention may comprise modified starch, e.g., at a concentration of about 1 kg/m³ to about 500 kg/m³, such as about 5 kg/m³ to about 100 kg/m³, or about 10 kg/m³ to about 50 kg/m³.

A composition of the invention may comprise calcium carbonate, e.g., at a concentration of about 10 kg/m³ to about 500 kg/m³, such as about 25 kg/m³ to about 400 kg/m³, or about 50 kg/m³ to about 250 kg/m³. The calcium carbonate may comprise particles ranging in size from about 1 m to about 500 m, such as about 2 m to about 200 μm.

A composition of the invention may comprise a fluid loss control agent such as an unmodified starch, hydroxypropyl starch, carboxymethyl starch, unmodified cellulose, carboxymethyl-cellulose, hydroxyethyl cellulose, and/or polyanionic cellulose.

A composition of the invention may comprise an aqueous or non-aqueous solvent. For example, a composition may comprise water.

A composition of the invention may comprise a viscosifier. A composition may comprise an alginate polymer such as one or more of sodium alginate, sodium calcium alginate, ammonium calcium alginate, ammonium alginate, potassium alginate, and/or propyleneglycol alginate. A composition may comprise organophillic clay, polyacrylamide, and/or xanthan gum. For example, a composition may comprise a mixture of xanthan gum and a cellulose derivative, e.g., with a weight ratio of about 80:20 to about 20:80. A cellulose derivative may be selected from hydroxyethylcellulose, hydroxypropylcellulose, carboxymethylcellulose, and mixtures of the foregoing. A composition may comprise bentonitic clay.

A composition of the invention may comprise a nonionic, water-soluble polysaccharide, such as a nonionic, water-soluble cellulosic derivative and/or a non-ionic water-soluble guar derivative. A composition may comprise an anionic water-soluble polysaccharide such as a carboxymethyl cellulose and/or Xanthomonas campestris polysaccharide. A composition may comprise an intermediate molecular weight polyglycol, such as polyethylene glycol, polypropylene glycol, and/or poly-(alkanediol), e.g., having an average molecular weight of from about 600 to about 30,000 amu.

A composition of the invention may comprise an aphron, polymer particle, thermoset polymer particle, and/or nanocomposite particulate. Aphrons may be about 50 to about 100 m in diameter, such as 25-100 m, 25-50 m, 5-50 m, 5-25 m, 7-15 m, or about 10 jm in diameter. A composition may comprise about 0.001% to about 5% of aphrons by mass.

A composition of the invention may comprise a polymer particle. A polymer particle may be substantially spherical. Typically, a polymer particle is solid and has a specific gravity of about 1.06. A polymer particle may have a fine or coarse grade. A composition may comprise a polymer particle at a concentration of about 2 ppb to about 12 ppb (e.g., about 5 to about 35 kg/m³), such as about 2 ppb to about 8 ppb or about 8 ppb to about 12 ppb.

A composition of the invention may comprise a thermoset polymer particle. A composition may comprise a nanocomposite particulate. A composition may comprise a co-polymer bead, such as Alpine Drill Beads (Alpine Specialty Chemicals, Houston, Tex.).

A composition of the invention may comprise one or more alkalinity agents, corrosion inhibitors, defoamers, dispersants, emulsifiers, fluid loss control agents, foaming agents (e.g., for gas-based fluids), corrosion inhibitors, lubricants, misting agents, oxygen scavengers, hydrosulfite scavengers, biocides, scale inhibitors, scale removers, shale inhibitors, solvents, specialty surfactants, thermal stabilizers, viscosifiers, and/or water purifiers.

A composition may comprise one or more lubricants in addition to the oleaginous yeast. A lubricant may comprise one or more of petroleum, petroleum distillate, paraffin, paraffin-based petroleum oil, hydrotreated light petroleum distillate, mineral oil, glycol ether, polyoxyalkylene glycol monoalkyl ether, polyethylene glycol, 1-(2-butoxy-1-methylethoxy)propan-2-ol, alkenes (e.g., C16 alkenes, C14-C18 alkenes), linear alkenes, olefins, C8-26 branched and linear hydrocarbons, C10-25 hydrocarbons, synthetic hydrocarbons, fatty acid, fatty acid esters, polymerized fatty acids, polymerized fatty esters, tall-oil, emulsifiers, diethylenetriamine, tetraethylenepentamine, triethylenetetramine, maleic anhydride, imidazoline, diesel, diesel oil, kerosene, ethylbenzene, naphthalene, methanol, graphite, silica, crystalline silica, silicate salt, quartz, cristobalite, tridymite, gypsum, lime, limestone, quaternary organoammonium montmorillonite, kaolin clay, alkyl quatemary ammonium bentonite, lignite, asphalt, gilsonite, calcium chloride, calcium chloride brine, cellulose, chromium (III) chloride hexahydrate, barium sulfate, and potassium magnesium sulfate. The one or more lubricants may be selected from fatty acids, tall oil, sulphonated detergents, phosphate esters, alkanolamides, asphalt sulfonates, graphite, and glass beads.

A composition of the invention may comprise one or more density modifiers (e.g., a weighting agent or weighting additive), such as barite, hematite, manganese oxide, calcium carbonate, iron carbonate, iron oxide, lead sulfide, siderate, and/or ilmenite.

A composition of the invention may comprise one or more emulsifiers. For example, a composition may comprise a nonionic emulsifier, such as an ethoxylated alkylphenol or ethoxylated linear alcohol, or an anionic emulsifier, such as an alkylaryl sulfonate, alcohol ether sulfonate, alkyl amine sulfonate, petroleum sulfonate, or phosphate ester.

A composition of the invention may comprise one or more additives selected from bentonite, xanthan gum, guar gum, starch, carboxymethylcellulose, hydroxyethyl cellulose, polyanionic cellulose, a biocide, a pH adjusting agent, polyacrylamide, an oxygen scavenger, a hydrogen sulfide scavenger, a foamer, a demulsifier, a corrosion inhibitor, a clay control agent, a dispersant, a flocculant, a friction reducer, a bridging agent, a lubricant, a viscosifier, a salt, a surfactant, an acid, a fluid loss control additive, a gas, an emulsifier, a density modifier, diesel fuel, and/or an aphron.

### III. Oleaginous Yeast

Suitable oleaginous yeast for use in a composition of the invention include, but are not limited to Arxula, Aspergillus, Aurantiochytrium, Candida, Claviceps, Cryptococcus, Cunninghamella, Geotrichum, Hansenula, Kluyveromyces, Kodamaea, Leucosporidiella, Lipomyces, Mortierella, Ogataea, Pichia, Prototheca, Rhizopus, Rhodosporidium, Rhodotorula, Saccharomyces, Schizosaccharomyces, Tremella, Trichosporon, Wickerhamomyces, and Yarrowia.

In some embodiments, the oleaginous yeast is selected from the group of consisting of Arxula adeninivorans, Aspergillus niger, Aspergillus orzyae, Aspergillus terreus, Aurantiochytrium limacinum, Candida utilis, Claviceps purpurea, Cryptococcus albidus, Cryptococcus curvatus, Cryptococcus ramirezgomezianus, Cryptococcus terreus, Cryptococcus wieringae, Cunninghamella echinulata, Cunninghamella japonica, Geotrichum fermentans, Hansenula polymorpha, Kluyveromyces lactis, Kluyveromyces marxianus, Kodamaea ohmeri, Leucosporidiella creatinivora, Lipomyces lipofer, Lipomyces starkeyi, Lipomyces tetrasporus, Mortierella isabellina, Mortierella alpina, Ogataea polymorpha, Pichia ciferrii, Pichia guilliermondii, Pichia pastoris, Pichia stipites, Prototheca zopfii, Rhizopus arrhizus, Rhodosporidium babjevae, Rhodosporidium toruloides, Rhodosporidium paludigenum, Rhodotorula glutinis, Rhodotorula mucilaginosa, Saccharomyces cerevisiae, Schizosaccharomyces pombe, Tremella enchepala, Trichosporon cutaneum, Trichosporon fermentans, Wickerhamomyces ciferrii, and Yarrowia lipolytica.

In some embodiments, the oleaginous yeast is not Rhodoturula glutinis or Rhodosporidium toruloides Banno.

Yarrowia lipolytica and Arxula adeninivorans are well suited for use as an oleaginous yeast of the invention because they can accumulate a large percentage of their weight as oil. Thus, the oleaginous yeast may be Yarrowia lipolytica orArxula adeninivorans.

In certain embodiments, the oleaginous yeast may be a high-temperature tolerant yeast, such as Kluyveromyces marxianus.

In some embodiments, the oleaginous yeast is not Candida apicola, Candida sp., Cryptococcus curvatus, Cryptococcus terricolus, Debaromyces hansenii, Endomycopsis vernalis, Geotrichum carabidarum, Geotrichum cucujoidarum, Geotrichum histeridarum, Geotrichum silvicola, Geotrichum vulgare, Hyphopichia burtonii, Lipomyces lipofer, Lypomyces orentalis, Lipomyces starkeyi, Lipomyces tetrasporous, Pichia mexicana, Rodosporidium sphaerocarpum, Rhodosporidium toruloides, Rhodotorula aurantiaca, Rhodotorula dairenensis, Rhodotorula diffluens, Rhodotorula glutinus, Rhodotorula glutinis var. glutinis, Rhodotorula gracilis, Rhodotorula graminis Rhodotorula minuta, Rhodotorula mucilaginosa, Rhodotorula mucilaginosa var. mucilaginosa, Rhodotorula terpenoidalis, Rhodotorula toruloides, Sporobolomyces alborubescens, Starmerella bombicola, Torulaspora delbruekii, Torulaspora pretoriensis, Trichosporon behrend, Trichosporon brassicae, Trichosporon domesticum, Trichosporon laibachii, Trichosporon loubieri, Trichosporon loubieri var. loubieri, Trichosporon montevideense, Trichosporon pullulans, Trichosporon sp., Wickerhamomyces Canadensis, Yarrowia lipolytica, or Zygoascus meyerae.

In some embodiments, the oleaginous yeast is not Mortierella, Mortierrla vinacea, Mortierella alpine, Pythium debaryanum, Mucor circinelloides, Aspergillus ochraceus, Aspergillus terreus, Pennicillium iilacinum, Hensenulo, Chaetomium, Cladosporium, Malbranchea, Rhizopus, or Pythium.

In certain embodiments, the oleaginous yeast comprises at least about 45 wt % oil, such as at least about 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt % oil. The oleaginous yeast may comprise about 45 wt % oil to 100 wt % oil, such as about 50 wt % oil to about 95 wt % oil, about 55 wt % oil to about 90 wt % oil, about 60 wt % oil to about 85 wt % oil, about 63 wt % oil to about 80 wt % oil, or about 65 wt % oil to about 75 wt % oil. The oleaginous yeast may comprise about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt % oil.

In certain embodiments, the oleaginous yeast comprises at least about 45 wt % fatty acids, such as at least about 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt % fatty acids. The oleaginous yeast may comprise about 45 wt % fatty acids to 100 wt % fatty acids, such as about 50 wt % fatty acids to about 95 wt % fatty acids, about 55 wt % fatty acids to about 90 wt % fatty acids, about 60 wt % fatty acids to about 85 wt % fatty acids, about 63 wt % fatty acids to about 80 wt % fatty acids, or about 65 wt % fatty acids to about 75 wt % fatty acids. The oleaginous yeast may comprise about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt % fatty acids.

In certain embodiments, the oleaginous yeast comprises at least about 50% oleic acid as a percentage of total lipids. In certain embodiments, the oleaginous yeast comprises at least about 50% oleic acid as a percentage of total C16 and C18 lipids. Yarrowia lipolytica strain YB-392 of the ARS Culture Collection, for example, comprises about 50% to about 62% oleic acid as a percentage of total C12 and C18 lipids. C16 lipids include palmitic acid (16:0) and palmitoleic (16:1) and C18 lipids include steric acid (18:0), oleic acid (18:1), linoleic acid (18:2), and α-linolenic acid (18:3).

In certain embodiments, the oleaginous yeast comprises at least about 50% oleic acid as a percentage of total lipids, such as at least about 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 78%, 79%, 80%, 81%, 82%, 83%, 84%, 85%, 86%, 87%, 88%, 89%, 90%, 91%, 92%, 93%, 94%, or 95% oleic acid as a percentage of total lipids. The oleaginous yeast may comprise 45% to 100% oleic acid as a percentage of total lipids, such as 50% to 100%, 55% to 100%, 60% to 100%, 65% to 100%, 70% to 100%, about 50% to about 95%, about 55% to about 95%, about 60% to about 95%, about 65% to about 95%, about 70% to about 95%, about 50% to about 90%, about 55% to about 90%, about 60% to about 90%, about 65% to about 90%, or about 70% to about 90% oleic acid as a percentage of total lipids. The oleaginous yeast may comprise about 50% oleic acid as a percentage of total lipids, such as about 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, or 95% oleic acid as a percentage of total lipids.

In certain embodiments, the oleaginous yeast comprises at least about 50% oleic acid as a percentage of total C16 and C18 lipids, such as at least about 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 73%, 74%, 75%, 77%, 78%, 79%, 80%, 81%, 82%, 83%, 84%, 85%, 86%, 87%, 88%, 89%, 90%, 91%, 92%, 93%, 94%, or 95% oleic acid as a percentage of total C16 and C18 lipids. The oleaginous yeast may comprise 45% to 100% oleic acid as a percentage of total C16 and C18 lipids, such as 50% to 100%, 55% to 100%, 60% to 100%, 65% to 100%, 70% to 100%, about 50% to about 95%, about 55% to about 95%, about 60% to about 95%, about 65% to about 95%, about 70% to about 95%, about 50% to about 90%, about 55% to about 90%, about 60% to about 90%, about 65% to about 90%, or about 70% to about 90% oleic acid as a percentage of total C16 and C18 lipids. The oleaginous yeast may comprise about 50% oleic acid as a percentage of total C16 and C18 lipids, such as about 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, or 95% oleic acid as a percentage of total C16 and C18 lipids.

An oleaginous yeast may be stable at pressures from 0.8 atm to 2 atm, 0.8 atm to 3 atm, 0.8 atm to 4 atm, 0.8 atm to 5 atm, 0.8 atm to 6 atm, 0.8 atm to 7 atm, 0.8 atm to 8 atm, 0.8 atm to 9 atm, 0.8 atm to 10 atm, 0.8 atm to 20 atm, 0.8 atm to 30 atm, 0.8 atm to 40 atm, 0.8 atm to 50 atm, 0.8 atm to 60 atm, 0.8 atm to 70 atm, 0.8 atm to 80 atm, 0.8 atm to 90 atm, 0.8 atm to 100 atm, 0.8 atm to 150 atm, 0.8 atm to 200 atm, 0.8 atm to 250 atm, 0.8 atm to 300 atm, 0.8 atm to 350 atm, 0.8 atm to 400 atm, 0.8 atm to 450 atm, 0.8 atm to 500 atm, 0.8 atm to 550 atm, 0.8 atm to 600 atm, 0.8 atm to 650 atm, 0.8 atm to 700 atm, 0.8 atm to 750 atm, 0.8 atm to 800 atm, 0.8 atm to 850 atm, 0.8 atm to 900 atm, 0.8 atm to 950 atm, or 0.8 atm to 1000 atm. An oleaginous yeast may be stable at a pressure less than or equal to 2 atm, 3 atm, 4 atm, 5 atm, 6 atm, 7 atm, 8 atm, 9 atm, 10 atm, 11 atm, 12 atm, 13 atm, 14 atm, 15 atm, 16 atm, 17 atm, 18 atm, 19 atm, 20 atm, 25 atm, 30 atm, 40 atm, 50 atm, 60 atm, 70 atm, 80 atm, 90 atm, 100 atm, 150 atm, 200 atm, 250 atm, 300 atm, 350 atm, 400 atm, 450 atm, 500 atm, 550 atm, 600 atm, 650 atm, 700 atm, 750 atm, 800 atm, 850 atm, 900 atm, 950 atm, or 1000 atm. The term “stable,” as used in relation to an oleaginous yeast at a certain pressure may refer to membrane stability, such as resistance to cell membrane lysis, and/or cell wall stability, such as resistance to cell wall rupture. The term “stable,” as used in relation to an oleaginous yeast at a certain pressure may refer to non-lethal pressures. In contrast with most algae and bacteria, yeast remain viable at hydrostatic pressures of up to 1000 atm; and genetic modifications, such as the addition of tryptophan permease Tat2, can further increase yeast stability at elevated pressures (see, e.g., Abe, F. and K. Horikoshi, Mol. Cell. Biol. 20(21):8093-01 (2000)). The ability for oleaginous yeast to withstand high pressures allows for the controlled release of lipids from the yeast by shearing (e.g., by a drill bit) rather than by intra-well pressures, which may approach 1000 atm in some cases (e.g., at depths approaching 10 km).

An oleaginous yeast of the invention may be grown in media comprising a substrate, such as a lignocellulose sugar, acetate, or glycerol (e.g., wherein a substrate is a waste product obtained from sugar refinery waste). Yeast such as Y. lipolytica can grow at low pH and do not require complex nutrients. For example, Yarrowia can grow in media comprising a simple sugar substrate, di-ammonium phosphate or urea, and vitamins, e.g. at a pH of about 5 to about 6. Simple sugars include lignocellulose C5 and C6 sugars (which are available at about 10 ¢/lb), acetate (which is available at less than 10 ¢/lb), and glycerol (which is available at less than 10 ¢/lb). Such growth conditions can be scaled without significantly affecting yields, thereby allowing the commercial production of inexpensive drilling fluid additives. Further, oleaginous yeast and growth conditions may be selected for production in non-sterilized systems, allowing additional cost savings.

### IV. Genetic Modifications to Oleaginous Yeast

An oleaginous yeast of the invention may comprise one or more genetic modifications that affect its lipid content or lipid composition. For example, the expression of a diacylglycerol acyltransferase may increase the oil content of a yeast (i.e., wt % oil). Similarly, the deletion of a triacylglycerol lipase may increase the oil content of a yeast.

An oleaginous yeast of the invention may comprise a genetic modification that increases diacylglycerol acyltransferase activity, e.g., as described in PCT Publication No. WO 2015/168531 (hereby incorporated by reference in its entirety). For example, an oleaginous yeast may be transformed with a nucleic acid encoding a diacylglycerol acyltransferase, e.g., to express the diacylglycerol acyltransferase in the yeast. The diacylglycerol acyltransferase may be a type 1 diacylglycerol acyltransferase, type 2 diacylglycerol acyltransferase, type 3 diacylglycerol acyltransferase, or any other protein that catalyzes the conversion of diacylglycerol into a triacylglyceride. In some embodiments, the diacylglycerol acyltransferase is DGA1. For example, the diacylglycerol acyltransferase may be a DGA1 protein encoded by a DGAT2 gene found in an organism selected from the group consisting of Arxula adeninivorans, Aspergillus terreus, Aurantiochytrium limacinum, Claviceps purpurea, Gloeophyllum trabeum, Lipomyces starkeyi, Microbotryum violaceum, Pichia guilliermondii, Phaeodactylum tricornutum, Puccinia graminis, Rhodosporidium diobovatum, Rhodosporidium toruloides, Rhodotorula graminis, and Yarrowia lipolytica.

In some embodiments, the diacylglycerol acyltransferase is DGA2. For example, the diacylglycerol acyltransferase may be a DGA2 protein encoded by a DGAT1 gene found in an organism selected from the group consisting of Arxula adeninivorans, Aspergillus terreus, Chaetomium globosum, Claviceps purpurea, Lipomyces starkeyi, Metarhizium acridum, Ophiocordyceps sinensis, Phaeodactylum tricornutum, Pichia guilliermondii, Rhodosporidium toruloides, Rhodotorula graminis, Trichoderma virens, and Yarrowia lipolytica.

In some embodiments, the diacylglycerol acyltransferase is DGA3. For example, the diacylglycerol acyltransferase may be a DGA3 protein encoded by a DGAT3 gene found in an organism selected from the group consisting of Ricinus communis and Arachis hypogaea.

The DGAT1, DGAT2, and DGAT3 genes may comprise conservative substitutions, deletions, and/or insertions while still encoding a protein that has functional diacylglycerol acyltransferase activity. For example, the DGAT1, DGAT2, or DGAT3 codons may be optimized for a particular host cell, different codons may be substituted for convenience, such as to introduce a restriction site or to create optimal PCR primers, or codons may be substituted for another purpose. Similarly, the nucleotide sequence may be altered to create conservative amino acid substitutions, deletions, and/or insertions. The DGA1, DGA2, and DGA3 polypeptides may comprise conservative substitutions, deletions, and/or insertions while still maintaining functional diacylglycerol acyltransferase activity. Conservative amino acid substitutions are well known (see, e.g., Creighton, Proteins (2d. ed., 1992)).

DNA and/or amino acid substitutions, deletions and/or insertions may readily be made using recombinant DNA manipulation techniques. Methods for the manipulation of DNA sequences to produce substitutions, insertions, or deletions are well known and include M13 mutagenesis, T7-Gen in vitro mutagenesis (USB, Cleveland, Ohio), Quick Change Site Directed mutagenesis (Stratagene, San Diego, Calif.), PCR-mediated site-directed mutagenesis, and other site-directed mutagenesis protocols.

Triacylglycerol lipase depletes a cell's triacylglycerol by removing one or more fatty acid chains. Thus, decreasing the net triacylglycerol lipase activity of a yeast may increase the wt % oil of the yeast. This decrease may be accomplished by reducing the efficiency of the enzyme, e.g., by mutating amino acids in its active site, or by reducing the expression of the enzyme. For example, a TGL3 knockout mutation will decrease the activity of a triacylglycerol lipase because such mutations prevent the cell from transcribing TGL3.

In some embodiments, the triacylglycerol lipase is TGL3, TGL3/4, or TGL4. The TGL3 gene in Y. lipolytica encodes the triacylglycerol lipase protein. Methods for knocking out the TGL3 gene in Y. lipolytica are described in PCT Patent Application Publication No. WO 2015/168531, published Nov. 5, 2015 (hereby incorporated by reference in its entirety). Similar methods may be used to reduce the activity of the TGL4 gene in Y. lipolytica, or to reduce the activity of a triacylglycerol lipase (e.g., TGL4, TGL3/4, or TGL4) in a different oleaginous yeast.

The deletion of various genes and/or expression of various enzymes in a yeast may increase the oleic acid content of the yeast (see, e.g., U.S. 62/090,169, filed Dec. 10, 2014, hereby incorporated by reference in its entirety). Deletion of the A12 desaturase gene from Y. lipolytica, for example, may increase the percentage of oleic acid to about 70% as a percentage of total C16 and C18 lipids, relative to wild type. Overexpressing a A9 desaturase gene, such as a A9 desaturase gene from Y. lipolytica or Puccinia graminis, can also increase oleic acid as a percentage of total C16 and C18 lipids. Overexpressing a elongase gene, such as a ELO1 from Y. lipolytica, can similarly increase oleic acid as a percentage of total C16 and C18 lipids.

### EXEMPLIFICATION

### Example 1—Yeast Strains

Strain NS432 is a recombinant strain of Yarrowia lipolytica described in PCT Patent Application Publication No. WO 2015/168531, published Nov. 5, 2015 (hereby incorporated by reference in its entirety). NS432 expresses DGA1 from Rhodosporidium toruloides and DGA2 from Claviceps purpurea, and it comprises a knockout of the TGL3 gene. Briefly, DGA1 from R. toruloides was overexpressed in Y. lipolytica strain YB-392 from the ARS Culture Collection. A recombinant yeast comprising a high lipid content was selected, and the gene for TGL3 was knocked out of this strain. DGA2 from C. purpurea was overexpressed in the resultant knock-out, and the yeast comprising the highest lipid content was named NS432. Strain NS432 comprises about 63 wt % oil to about 75 wt % oil when grown in laboratory conditions. The NS432 product used as a lubricant in the following examples contained 70.1 wt % oil.

Strain NS551 is also a recombinant strain of Y. lipolytica that was generated from strain YB-392 of the ARS Culture Collection. NS551 was generated by over first overexpressing Y. lipolytica DGA1, then overexpressing C. purpurea DGA2, then knocking out the Δ12 desaturase gene, then overexpressing Y. lipolytica ELO1, then overexpressing Y. lipolytica Δ9 desaturase. Strain NS551 comprises 87% oleic acid as a percentage of total C16 and C18 lipids. The NS551 product used as a lubricant in the following examples contained 65.3 wt % oil.

### Example 2—Drilling Fluid Preparation

A fresh water drilling fluid was prepared in a Silverson mixer according to Table 1.

TABLE 1
Composition and Preparation of a Drilling Fluid

| Product | Type | Concentration | | Mixing time |
|---|---|---|---|---|
| Fresh water | | 1 | m³ | |
| Sodium Carbonate | pH control | 1 | kg/m³ | 2 min |
| Caustic soda | pH control | 1 | kg/m³ | 2 min |
| NaCl | Salinity | 134 | kg/m³ | 5 min |
| Baroid Filter-Check | Filtration control | 20 | kg/m³ | 15 min |
| | (modified starch) | | | |
| Baroid Barazan D | Viscosity control | 4 | kg/m³ | 15 min |
| | (XC polymer and | | | |
| | other polymers) | | | |
| CaCO₃ - 5μ | Filtration control | 20 | kg/m³ | 5 min |
| CaCO₃ - 25μ | Filtration control | 40 | kg/m³ | 5 min |
| CaCO₃ - 50μ | Filtration control | 40 | kg/m³ | 5 min |

After preparing the formulation according to Table 1, lubricants were added over 5 minutes in a Raynerie mixer. The Raynerie mixer was used to add the lubricants to avoid shearing in the Silverson mixer. Drilling fluids were prepared using 1%, 2%, 3%, and 4% oil added as strain NS432, strain NS551, or Baroid BARO-LUBE GOLD SEAL. Yeast was normalized according to oil content, i.e., NS432, which contains 70.1% oil, and NS551, which contains 65.3% oil, were added to achieve 1%, 2%, 3%, or 4% total oil in the drilling fluid mixtures. Additionally, a drilling fluid was prepared without oil as a control.

The BARO-LUBE GOLD SEAL product data sheet recommends adding 2% by volume of the lubricant to drilling fluid, up to 5% by volume for severe cases and/or for heavily weighted drilling fluids. BARO-LUBE GOLD SEAL's Material Safety Data Sheet states that it comprises 60-100% soybean oil and 5-10% polypropylene glycol.

### Example 3—Screening Tests to Define Optimum Lubricant Concentrations

The performance of various drilling fluids was assessed in an OFITE Lubricity and Extreme Pressure Tester. The instrument applies force between two hardened steel surfaces, a block and a ring rotating at a desired speed. Drilling fluids containing 1%, 2%, or 3% total oil as Baroid Baro-Lube Gold Seal were assessed with 125 in x lbs force and 150 RPM rotation to mirror standard lubricant testing protocols (e.g., Johnson, P. et al., Am. Assoc. Drilling Engineers, Fluids Technical Conference and Exhibition, Paper #AADE-14-FTCE-10 (Houston, Tex., Apr. 15-16, 2014), available at www.aade.org/app/download/7238016322/AADE-14-FTCE-10.pdf). Stable readings were obtained, and friction factors did not display time dependency.

TABLE 2
Performance of Drilling Fluids Comprising Various Concentrations
of Baroid Baro-Lube Gold Seal Lubricant

| | | |
|---|---|---|
| Time min | Temperature ° C. | Friction factor |

BARO-LUBE GOLD SEAL ™ 1%

| | | |
|---|---|---|
| 0 | 22.4 | 0.05 |
| 2 | 22.6 | 0.05 |
| 4 | 22.8 | 0.04 |
| 15 | 23.9 | 0.04 |
| 30 | 24.9 | 0.04 |

BARO-LUBE GOLD SEAL ™ 2%

| | | |
|---|---|---|
| 0 | 22.8 | 0.04 |
| 2 | 23 | 0.04 |
| 15 | 24.7 | 0.04 |
| 41 | 27 | 0.045 |
| 65 | 28.6 | 0.04 |

BARO-LUBE GOLD SEAL ™ 3%

| | | |
|---|---|---|
| 0 | 23.1 | 0.04 |
| 2 | 23.6 | 0.04 |
| 39 | 28 | 0.045 |

The friction factor of fresh water was assessed with 150 in x lbs force and 50 RPM as a control. A friction factor of 0.34 was observed, which is consistent with known results. The temperature of the drilling fluid increased over the course of the experiment, consistent with the elevated friction factor.

TABLE 3
Friction Factors for Fresh Water
Fresh Water

| Time min | Temperature ° C. | Friction factor |
|---|---|---|
| 0 | 24° C. | 0.34 |
| 15 | 45° C. | 0.34 |
| 120 | 78° C. | 0.34 |

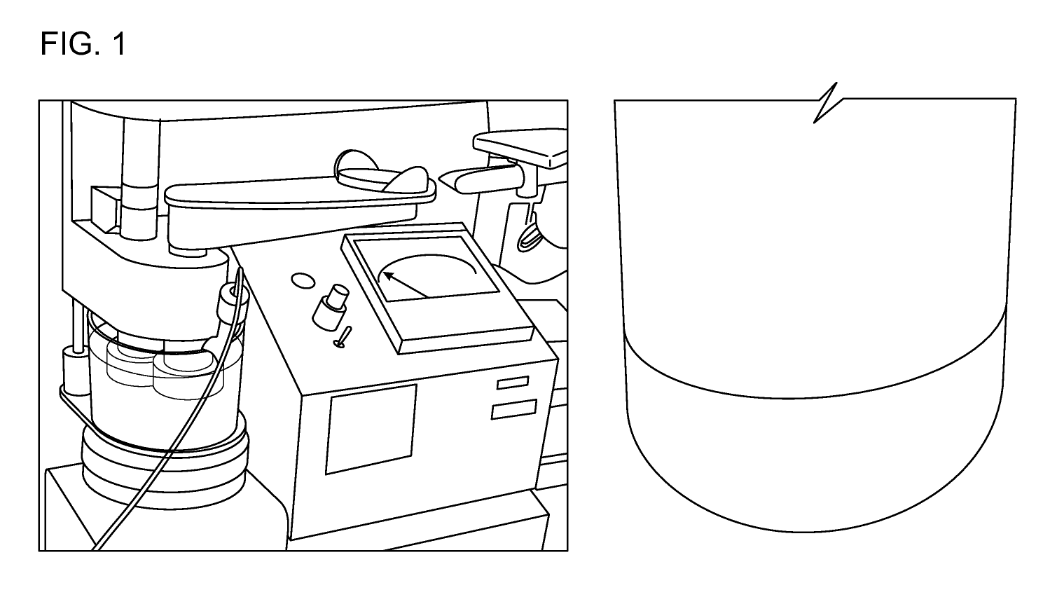

Drilling fluids containing 1%, 2%, 3%, or 4% total oil as NS432, provided as a powder, were assessed with 125 in x lbs force and 150 RPM rotation in an OFITE Lubricity and Extreme Pressure Tester. The friction factor decreased with increasing time, suggesting that oil was released during the course of the test. At 1% and 3% oil, the friction factors decreased to a minimum, and then tended to increase with time. The observed increase in friction factor could be caused by increased solids in the drilling fluid with time. FIG. 1, for example, is a photograph of a 3% total oil sample for NS432, which depicts solids at the bottom of the vessel.

TABLE 4
Performance of Drilling Fluids Comprising
Various Concentrations of NS432 Lubricant

| | | |
|---|---|---|
| Time min | Temperature ° C. | Friction factor |

NS432 1%

| | | |
|---|---|---|
| 0 | 22.6 | 0.13 |
| 1 | 23 | 0.11 |
| 2 | 23.4 | 0.1 |
| 5 | 24.5 | 0.095 |
| 10 | 26 | 0.1 |
| 15 | 27.4 | 0.1 |
| 30 | 30.8 | 0.1 |
| 45 | 33 | 0.1 |
| 60 | 34.9 | 0.105 |
| 75 | 36.8 | 0.11 |
| 90 | 40.4 | 0.13 |
| 120 | 41.9 | 0.14 |

NS432 2%

| | | |
|---|---|---|
| 0 | 20.8 | 0.17 |
| 2 | 21.8 | 0.15 |
| 4 | 22.8 | 0.13 |
| 10 | 23.9 | 0.11 |
| 15 | 26.2 | 0.105 |
| 20 | 28.1 | 0.105 |
| 30 | 29.7 | 0.1 |
| 45 | 31.9 | 0.1 |
| 60 | 33.5 | 0.1 |
| 75 | 34.3 | 0.1 |
| 90 | 34.8 | 0.09 |
| 105 | 35 | 0.09 |
| 120 | 35.1 | 0.09 |

NS432 3%

| | | |
|---|---|---|
| 0 | 22.2 | 0.12 |
| 2 | 23.1 | 0.12 |
| 5 | 24 | 0.115 |
| 10 | 25.8 | 0.12 |
| 20 | 28.6 | 0.115 |
| 37 | 31.9 | 0.105 |
| 45 | 32.8 | 0.105 |
| 60 | 34.9 | 0.11 |
| 75 | 37 | 0.12 |
| 120 | 40.2 | 0.12 |

NS432 4%

| | | |
|---|---|---|
| 0 | 21.4 | 0.19 |
| 0.5 | 21.6 | 0.17 |
| 1 | 22 | 0.19 |
| 2 | 23 | 0.2 |
| 3 | 23.5 | 0.21 |
| 5 | 24.4 | 0.215 |
| 10 | 27.7 | 0.19 |
| 15 | 30 | 0.17 |
| 30 | 34 | 0.155 |
| 49 | 36.5 | 0.135 |
| 60 | 37.2 | 0.13 |
| 75 | 37.8 | 0.12 |
| 90 | 37.9 | 0.11 |
| 105 | 37.9 | 0.11 |
| 120 | 37.9 | 0.11 |

These tests demonstrate that NS432 is an efficient, water-based drilling fluid lubricant, which can provide a friction factor of less than 0.10 and up to a 74% reduction in friction factor relative to water. Based on these tests, 2% total oil as NS432 was used in subsequent experiments.

Drilling fluids containing 1%, 2%, or 3% total oil as NS551, provided as a powder, were assessed with 125 in x lbs force and 150 RPM rotation in an OFITE Lubricity and Extreme Pressure Tester. The friction factor decreased with increasing time, suggesting that oil was released during the course of the test.

These tests demonstrate that NS551 is an efficient, water-based drilling fluid lubricant, which can provide up to a 59% reduction in friction factor relative to water. Based on these tests, 1% total oil as NS551 was used in subsequent experiments.

TABLE 5
Performance of Drilling Fluids Comprising
Various Concentrations of NS551 Lubricant

| | | |
|---|---|---|
| Time min | Temperature ° C. | Friction factor |

NS551 1%

| | | |
|---|---|---|
| 0 | 22.4 | 0.16 |
| 1 | 22.5 | 0.145 |
| 2 | 22.9 | 0.17 |
| 3 | 23.4 | 0.185 |
| 5 | 24.9 | 0.185 |
| 10 | 27.8 | 0.18 |
| 15 | 30 | 0.155 |
| 20 | 32.1 | 0.15 |
| 30 | 35.7 | 0.145 |
| 47 | 38.9 | 0.15 |
| 60 | 41.5 | 0.16 |
| 95 | 43.3 | 0.155 |
| 120 | 45.8 | 0.165 |

NS551 2%

| | | |
|---|---|---|
| 0 | 22 | 0.215 |
| 1 | 22.8 | 0.198 |
| 2 | 23.8 | 0.185 |
| 5 | 25.3 | 0.17 |
| 10 | 27.5 | 0.16 |
| 20 | 32.4 | 0.16 |
| 30 | 35.4 | 0.16 |
| 45 | 38.9 | 0.16 |
| 60 | 42 | 0.17 |
| 105 | 48 | 0.2 |
| 107 | 50.8 | 0.22 |
| 120 | 52.5 | 0.225 |

NS551 3%

| | | |
|---|---|---|
| 0 | 21.6 | 0.23 |
| 1 | 21.7 | 0.22 |
| 2 | 22.6 | 0.22 |
| 5 | 25 | 0.215 |
| 10 | 28.7 | 0.215 |
| 15 | 32.5 | 0.21 |
| 33 | 40.4 | 0.2 |
| 50 | 43.9 | 0.2 |
| 60 | 45.8 | 0.195 |
| 90 | 48 | 0.19 |
| 105 | 48.7 | 0.195 |
| 120 | 49.7 | 0.2 |

### Example 4—Lubricant Performance

Drilling fluids were prepared according to Example 2, comprising mud without lubricant, mud with 3% BARO-LUBE GOLD SEAL lubricant, and mud with 3% total oil supplied as NS432. Each drilling fluid was hot rolled for 16 hours at 60° C. to simulate well conditions. The NS432 lubricant displayed no adverse effect on the drilling mud, and fluid loss was reduced. NS432 displayed an effect on the rheology, with a thinning of the fluid to values which were not detrimental to the buoyancy of the solids, and no decanting was observed.

TABLE 6
Performance of Various Drilling Fluids after 16 Hours of Hot Rolling at 60° C.

| | | Units | Mud | Mud + 3% Barolube | Mud + 3% NS 432 |
|---|---|---|---|---|---|
| TEST | | | | | |
| DENSITY @ 27° C. | | SG | 1.15 | 1.15 | 1.15 |
| RHEOLOGY | | | | | |
| 600 | rpm | Temp ° C. | 30 | 30 | 30 |
| 300 | rpm | | 88 | 88 | 47 |
| 200 | rpm | | 64 | 64 | 32 |
| 100 | rpm | | 53 | 53 | 26 |
| 60 | rpm | | 39 | 39 | 19 |
| 30 | rpm | | 32 | 32 | 16 |
| 6 | rpm | | 23 | 25 | 13 |
| 3 | rpm | | 14 | 10 | 7 |
| | | | 11 | 12 | 6 |

| | | | | |
|---|---|---|---|---|
| GELS 10″ | lbf/100 ft² | 12 | 12 | 6 |
| GELS 10′ | lbf/100 ft² | 16 | 15 | 9 |
| PLASTIC VISCOSITY (PV = F600 − F300) | cP | 24 | 24 | 15 |
| YIELD POINT (YP = F300 − PV) | lbf/100 ft² | 40 | 40 | 17 |
| LOW SHEAR YIELD = 0.5 × (F3 + F6) | | 12.5 | 11 | 6.5 |
| YIELD STRESS = 2 × F3 − F6 | lbf/100 ft² | 8 | 14 | 5 |
| HPHT FILTRATION | | | | |
| Temperature | ° C. | TA | TA | TA |
| Differential Pressure | psi | 100 | 100 | 100 |
| Volume Collected (@ 30 min) | mL | 6 | 4 | 4 |
| CAKE THICKNESS | mm | 1 | 2 | 1 |
| pH | | | | |

| | | | |
|---|---|---|---|
| pH | 8.7 | 8.7 | 8.3 |

Rheologies were measured again, just after mixing, to determine whether the thinning behavior observed for NS432 occurred before or after hot rolling. Under these conditions, the drilling fluid comprising 3% oil as NS432 displayed the same rheological parameters as drilling fluid without lubricant (Table 7).

TABLE 7
Rheologies of Various Drilling Fluids without Hot Rolling

| RHEOLOGY bis | | Units | Mud | Mud + 3% NS 432 |
|---|---|---|---|---|
| | | Temp ° C. | 30 | 30 |
| 600 | rpm | | 83 | 93 |
| 300 | rpm | | 57 | 65 |
| 200 | rpm | | 46 | 53 |
| 100 | rpm | | 33 | 38 |
| 60 | rpm | | 26 | 31 |
| 30 | rpm | | 19 | 23 |
| 6 | rpm | | 10 | 12 |
| 3 | rpm | | 8 | 9 |

| | | | |
|---|---|---|---|
| GELS 10″ | lbf/100 ft² | 9 | — |
| GELS 10′ | lbf/100 ft² | 11 | — |
| PLASTIC VISCOSITY (PV = F600 − F300) | cP | 26 | 28 |
| YIELD POINT (YP = F300 − PV) | lbf/100 ft² | 31 | 37 |
| LOW SHEAR YIELD = 0.5 × (F3 + F6) | | 9 | 10.5 |
| YIELD STRESS = 2 × F3 − F6 | lbf/100 ft² | 6 | 6 |

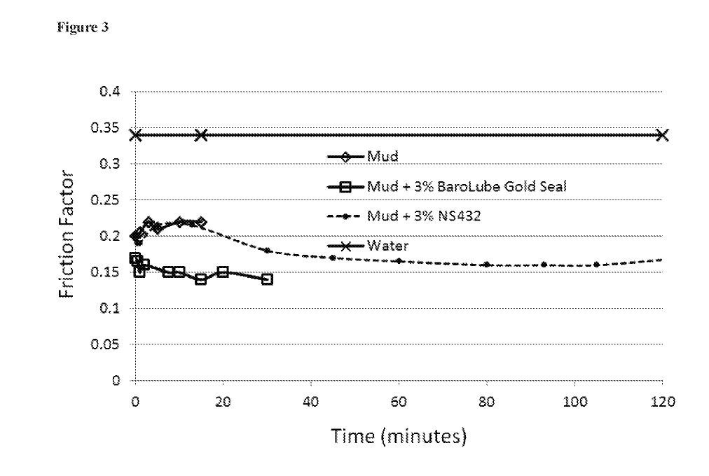

Lubricity was measured under the conditions described in Example 3 for the drilling fluids comprising mud without lubricant, mud with 3% BARO-LUBE GOLD SEAL lubricant, and mud with 3% total oil supplied as NS432, after hot rolling each fluid (FIG. 3). Drilling fluid without lubricant exhibited a friction factor less than fresh water, but resulted in heavy scoring on the block, requiring premature stoppage of the experiment. The hot-rolled drilling fluid comprising 3% BARO-LUBE GOLD SEAL resulted in a friction factor that stabilized at about 0.14 after 30 minutes. The hot-rolled drilling fluid comprising 3% oil supplied as NS432 resulted in a friction factor that stabilized at about 0.16.

### INCORPORATION BY REFERENCE

All of the patents, published patent applications, and other references cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

What is claimed is:

1.-21. (canceled)

22. A composition for use in drilling or maintaining a wellbore, comprising an oleaginous yeast, wherein the oleaginous yeast is not Rhodoturula glutinis, wherein the oleaginous yeast comprises a genetic modification selected from the group consisting of:
a genetic modification that increases the oil content of the yeast;
a genetic modification that alters the lipid composition of the yeast; and
a genetic modification that provides a selective advantage for the yeast, relative to an unmodified yeast of the same species.

23. The composition of claim 22, wherein the oleaginous yeast comprises at least about 45 wt % oil.

24. The composition of claim 22, wherein at least about 10 wt % of the lipids of the yeast are oleic acid.

25. The composition of claim 22, wherein less than about 10 wt % of the lipids of the yeast are polyunsaturated.

26. The composition of claim 22, wherein the oleaginous yeast comprises at least about 60 wt % oil.

27. The composition of claim 22, wherein at least about 70 wt % of the lipids of the yeast are oleic acid.

28. The composition of claim 22, wherein the oleaginous yeast comprises a genetic modification that increases diacylglycerol acyltransferase activity.

29. The composition of claim 28, wherein the genetic modification that increases diacylglycerol acyltransferase activity is transformation with an amino acid that encodes a diacylglycerol acyltransferase.

30. The composition of claim 29, wherein the diacylglycerol acyltransferase is DGA1, DGA2, or DGA3.

31. The composition of claim 22, wherein the oleaginous yeast comprises a genetic modification that decreases triacylglycerol lipase activity.

32. The composition of claim 31, wherein the genetic modification that decreases triacylglycerol lipase activity is a knockout mutation.

33. The composition of claim 32, wherein the triacylglycerol lipase is TGL3, TGL3/4, or TGL4.

34. The composition of claim 22, wherein the oleaginous yeast is selected from the group of consisting of Arxula, Aspergillus, Aurantiochytrium, Candida, Claviceps, Cryptococcus, Cunninghamella, Geotrichum, Hansenula, Kluyveromyces, Kodamaea, Leucosporidiella, Lipomyces, Mortierella, Ogataea, Pichia, Prototheca, Rhizopus, Rhodosporidium, Rhodotorula, Saccharomyces, Schizosaccharomyces, Tremella, Trichosporon, Wickerhamomyces, and Yarrowia.

35. The composition of claim 22, wherein the oleaginous yeast is selected from the group of consisting of Arxula adeninivorans, Aspergillus niger, Aspergillus orzyae, Aspergillus terreus, Aurantiochytrium limacinum, Candida utilis, Claviceps purpurea, Cryptococcus albidus, Cryptococcus curvatus, Cryptococcus ramirezgomezianus, Cryptococcus terreus, Cryptococcus wieringae, Cunninghamella echinulata, Cunninghamella japonica, Geotrichum fermentans, Hansenula polymorpha, Kluyveromyces lactis, Kluyveromyces marxianus, Kodamaea ohmeri, Leucosporidiella creatinivora, Lipomyces lipofer, Lipomyces starkeyi, Lipomyces tetrasporus, Mortierella isabellina, Mortierella alpina, Ogataea polymorpha, Pichia ciferrii, Pichia guilliermondii, Pichia pastoris, Pichia stipites, Prototheca zopfii, Rhizopus arrhizus, Rhodosporidium babjevae, Rhodosporidium toruloides, Rhodosporidium paludigenum, Rhodotorula glutinis, Rhodotorula mucilaginosa, Saccharomyces cerevisiae, Schizosaccharomyces pombe, Tremella enchepala, Trichosporon cutaneum, Trichosporonfermentans, Wickerhamomyces ciferrii, and Yarrowia lipolytica.

36. The composition of claim 22, wherein the oleaginous yeast is not Aspergillus ochraceus, Aspergillus terreus, Candida apicola, Candida sp., Cladosporium, Cryptococcus curvatus, Cryptococcus terricolus, Debaromyces hansenii, Endomycopsis vernalis, Geotrichum carabidarum, Geotrichum cucujoidarum, Geotrichum histeridarum, Geotrichum silvicola, Geotrichum vulgare, Hensenulo, Chaetomium, Hyphopichia burtonii, Lipomyces lipofer, Lypomyces orentalis, Lipomyces starkeyi, Lipomyces tetrasporous, Malbranchea, Mortierella, Mortierrla vinacea, Mortierella alpine, Mucor circinelloides, Pennicillium iilacinum, Pichia mexicana, Pythium, Pythium debaryanum, Rhizopus, Rodosporidium sphaerocarpum, Rhodosporidium toruloides, Rhodotorula aurantiaca, Rhodotorula dairenensis, Rhodotorula diffluens, Rhodotorula glutinus, Rhodotorula glutinis var. glutinis, Rhodotorula gracilis, Rhodotorula graminis Rhodotorula minuta, Rhodotorula mucilaginosa, Rhodotorula mucilaginosa var. mucilaginosa, Rhodotorula terpenoidalis, Rhodotorula toruloides, Sporobolomyces alborubescens, Starmerella bombicola, Torulaspora delbruekii, Torulaspora pretoriensis, Trichosporon behrend, Trichosporon brassicae, Trichosporon domesticum, Trichosporon laibachii, Trichosporon loubieri, Trichosporon loubieri var. loubieri, Trichosporon montevideense, Trichosporon pullulans, Trichosporon sp., Wickerhamomyces Canadensis, Yarrowia lipolytica, or Zygoascus meyerae.

37. The composition of claim 36, wherein the oleaginous yeast is Yarrowia lipolytica or Arxula adeninivorans.

38. The composition of claim 22, wherein the cell wall of the oleaginous yeast is stable at pressures from 0.8 atmospheres to 5 atmospheres.

39. The composition of claim 22, wherein the composition is a cake or cream.

40. A method for drilling or maintaining a wellbore, comprising the step of drilling the wellbore with a drilling rig, wherein the wellbore comprises a composition of claim 22.

41. A method for drilling or maintaining a wellbore, comprising the steps of contacting a drill bit or a drill rod with the composition of claim 22, and drilling the wellbore with the drill bit or the drill rod.
